(19) United States
(12) Patent Application Publication
(10) Pub. No.: US 2025/0278578 A1
(43) Pub. Date: Sep. 4, 2025

(54) INTERMEDIARY ROUTING AND MODERATION PLATFORM FOR GENERATIVE ARTIFICIAL INTELLIGENCE SYSTEM INTERFACING

(71) Applicant: Target Brands, Inc., Minneapolis, MN (US)

(72) Inventors: Anshul Chawla, Minneapolis, MN (US); Visagan Vaithyanathan, Minneapolis, MN (US); Andrew Thomas Guck, Plymouth, MN (US); Aaron Peloquin, Maple Grove, MN (US); Matthew Sullivan, Minneapolis, MN (US); Gopikrishna Chaganti, Karnataka (IN)

(21) Appl. No.: 19/070,120

(22) Filed: Mar. 4, 2025

Related U.S. Application Data
(60) Provisional application No. 63/561,109, filed on Mar. 4, 2024.

(51) Int. Cl. G06F 40/40; G06F 16/3331

(52) U.S. Cl. CPC G06F 40/40; G06F 16/3331

(57) ABSTRACT

A routing and moderation platform enables enterprise management of input queries and associated responses that may be submitted to and received from generative artificial intelligence (AI) systems. The routing and moderation platform includes an application programming interface (API) that enables an enterprise to interface with a plurality of different LLM-based generative AI systems. The API may route an input query and any related contextual information and additional instructions for forming a response to the input query to a selected LLM-based generative AI system, and receive a response in response thereto. The routing may be based, at least in part, on the particular source of a question and context of that question. The routing and moderation platform further includes a moderation service useable to quantify a quality of the response received from any of the generative AI systems accessed via the API.

### CROSS-REFERENCE TO RELATED APPLICATIONS

This application claims priority to U.S. provisional patent application 63/561,109, filed on Mar. 4, 2024; the disclosure of which is incorporated herein by reference in its entirety.

### BACKGROUND

Generative artificial intelligence (AI) systems are recently entering widespread use. Such systems may include generative AI platforms that are based on large language models (LLMs) and other types of models that may generate text responses to questions submitted by users. In this context, such generative AI systems may provide inaccurate responses due to lacking access to adequate training or contextual data. Additionally, some such generative AI systems may begin to “hallucinate” by generating responses to user queries that are no longer based in fact. Furthermore, different versions of such generative AI systems may be better or worse at being directly responsive to the questions presented by users. Still further, different generative AI systems may have differing costs of submitting questions and receiving answers in response. For example, a larger LLM model may have a computational cost or subscription cost that is higher than that of a smaller, more “lightweight” model.

For this reason, users may often submit queries to a particular generative AI platform, and may iterate questions submitted to that particular platform to arrive at a desired answer. However, that approach may not be the one that most efficiently arrives at an answer satisfactory to the user (e.g., in terms of cost, completeness, accuracy, or other metrics). Furthermore, it may be difficult for a user to determine the overall quality of response from a particular model.

### SUMMARY

In general, a routing and moderation platform is described that enables enterprise management of input queries and responses to the input queries submitted to and received from generative AI systems. The routing and moderation platform may include an application programming interface (API) that enables an enterprise to interface with a plurality of different LLM-based generative AI systems. The API may, based on the particular source of an input query and context of that input query, route the query and any related contextual information to one or more generative AI systems, and receive answers in response thereto. The routing and moderation platform further includes a prompt templating service useable to generate prompts appropriate to elicit responsive answers from the selected generative AI systems, as well as a moderation service useable to quantify a quality of response received from any of the generative AI systems accessed via the API.

In a first embodiment, a routing and moderation platform is disclosed. The routing and moderation platform comprises: a routing application programming interface communicatively interfaced to a plurality of tenant devices to: receive an input query submitted from a tenant device of the plurality of tenant devices; and identify an LLM-based generative AI system from a plurality of LLM-based generative AI systems to invoke to respond to the input query; a prompt templating service executable to: obtain contextual information that is relevant to the input query from one or more enterprise systems; generate instructions for constructing a response to the input query; generate a prompt based on the input query, the contextual information and the instructions; generate a tuned prompt by compressing the number of tokens included within the prompt; wherein the routing application programming interface is further configured to submit the tuned prompt to the LLM-based generative AI system and receive the response to the input query.

In a second embodiment, a routing and moderation platform is disclosed. The routing and moderation platform comprises: a computing system comprising a processor and a memory, the computing system including instructions which, when executed, cause the routing and moderation platform to perform: receiving an input query submitted from a tenant device of the plurality of tenant devices; and identifying an LLM-based generative AI system from a plurality of LLM-based generative AI systems to invoke to respond to the input query; obtaining contextual information that is relevant to the input query from one or more enterprise systems; generating instructions for constructing a response to the input query; generating a prompt based on the input query, the contextual information and the instructions; generating a tuned prompt by compressing the number of tokens included within the prompt; and submitting the tuned prompt to the LLM-based generative AI system; receiving the response to the input query; generating an average quality score for the response; and upon determining that the average quality score meets a threshold quality value, sending the response to the tenant device.

In a third embodiment, a method for routing and moderation of questions received from tenants is disclosed. The method comprises: receiving an input query submitted from a tenant device of the plurality of tenant devices; and determining an LLM-based generative AI system from a plurality of LLM-based generative AI systems to invoke to respond to the input query; obtaining contextual information that is relevant to the input query from one or more enterprise systems; generating instructions for constructing a response to the input query; generating a prompt based on the input query, the contextual information and the instructions; generating a tuned prompt by compressing the number of tokens included within the prompt; and submitting the tuned prompt to the LLM-based generative AI system.

### BRIEF DESCRIPTION OF THE DRAWINGS

FIG. 1 is a schematic diagram illustrating an example environment in which aspects of the present disclosure may be implemented.

FIG. 2 is a schematic diagram illustrating an example environment in which aspects of the present disclosure may be implemented.

FIG. 3 is a schematic diagram illustrating use of an API as part of a routing and moderation platform in accordance with aspects of the present disclosure.

FIG. 4 illustrates an example computing system with which aspects of the present disclosure may be implemented.

FIG. 5 is a flowchart of an example method for routing of input queries received from tenants in accordance with aspects of the present disclosure.

FIG. 6 is a flowchart of an example method for moderation of an input query received from a tenant in accordance with aspects of the present disclosure.

FIG. 7 is a flowchart of another example method for moderation of input queries received from tenants in accordance with aspects of the present disclosure.

### DETAILED DESCRIPTION

As briefly described above, embodiments of the present invention are directed to a routing and moderation platform that enables enterprise management of input queries and answers that may be submitted to and received from generative artificial intelligence (AI) systems. The routing and moderation platform may include an application programming interface (API) that enables an enterprise to interface with a plurality of different LLM-based generative AI systems. The API may, based on the particular source of an input query and context of that input query, route an input query and any related contextual information to one or more generative AI systems, and receive answers in response thereto. The routing and moderation platform further includes a prompt templating service useable to generate prompts appropriate to elicit responsive answers from the selected generative AI systems, as well as a moderation service useable to quantify a quality of response received from any of the generative AI systems accessed via the API.

In example embodiments, the routing and moderation platform enables access to either enterprise-specific LLM models or external LLM models that may be publicly accessible. The routing and moderation platform may select a particular model based on an identity of an entity submitting an input query (e.g., a tenant) and the context of the specific input query, as well as based on historical information indicating a confidence that the particular generative AI model will return a responsive answer above a particular quality threshold. Metrics for quantifying the quality of response may be provided by the moderation service. Quality of response may be based on the tenant and context of an input query submitted.

Such a routing and moderation platform enables enterprise control over quality of answers provided to various tenants. Particular tenants may require highly-reliable response information (e.g., customers who are requesting product or part information, availability, hours, item detail, and the like) while other tenants may be willing to forego a level of accuracy (e.g., product designers seeking idea generation regarding product names, and the like). Still further, over time, generative AI models continue to evolve in terms of responsiveness, accuracy, available training corpus, and the like. Some may be trained on sensitive enterprise data and may only be available to answer input queries within the enterprise (e.g., relating to sales projections, materials or source pricing, and the like), while others may be trained using a broader set of public data, and may be more broadly available while lacking the enterprise-specific detail. Some generative AI models may be better or worse at generating answers of various formats (e.g., narrative textual answers, source code, etc.) Additionally, data rights may differ with respect to the various generative AI models to which input queries might be submitted. As such, the routing and moderation platform enables control over submission of input queries to one or more of the various generative AI models that are available, as well as assessment and selection of answers in response to ensure reliable tenant interactions.

### I. Example Environment and Description of Platform

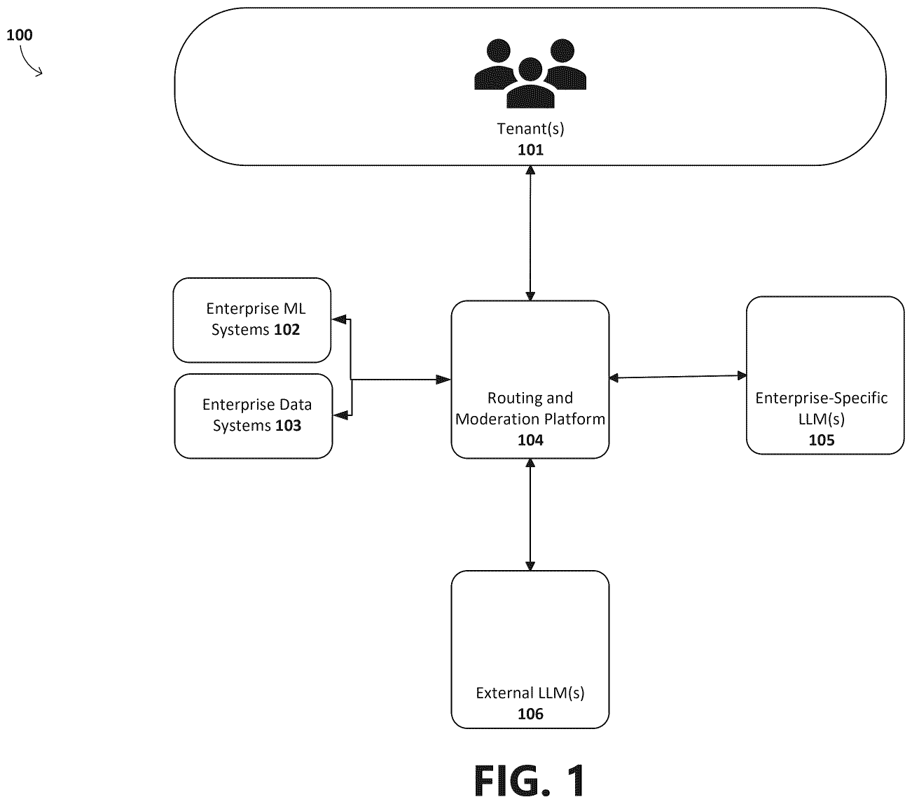

FIG. 1 illustrates an example environment 100 in which aspects of the present disclosure may be implemented. One or more aspects of the environment 100 can be used to implement the processes described herein. The environment can be hosted, in whole or in part, by an enterprise, such as a retail enterprise.

In the example shown, one or more tenant 101 may receive an input query from a tenant. The tenant may be any of a variety of types of tenant devices used by different types of users. For example, a tenant may be associated with an employee of the enterprise, such as a product designer, a store employee, a software developer, or a data scientist. A tenant may be associated with a customer of the enterprise, such as in the case where the enterprise is a retail enterprise. As is understood, different ones of the tenants may have different desired responses to input queries to be submitted to a generative AI system.

In the example shown, the one or more tenant 101 submits input queries that are routed to a routing and moderation platform 104. The routing and moderation platform 104 manages data flow from one or more tenants 101 to and from various generative AI systems. Such generative AI systems may include, for example, an enterprise-specific large language model (LLM) 105 or an external LLM 106.

In example implementations, an enterprise-specific LLM 105 may be an LLM that is tuned to answer input queries specifically likely to be asked of the enterprise, and may have be trained or tuned using a customized dataset. For example, in some instances, an enterprise-specific LLM 105 may be best to respond to input queries about information such as specific item details of an item offered for sale by the enterprise, store hours, in-stock status, and the like. In other examples, an enterprise-specific LLM 105 may be trained using an enterprise dataset, such as an enterprise codebase stored in a code repository, in order to generate enterprise-specific answers to input queries, such as to generate compatible enterprise source code to assist developers with coding tasks. Numerous other enterprise-specific examples are possible as well.

In example implementations, an external LLM 106 may be implemented as a public LLM, such as ChatGPT or one hosted on cloud such as Google Cloud Platform (GCP). In some embodiments, an external LLM 106 may be utilized to answer general input queries that do not require enterprise knowledge, or which may form a response using a provided knowledge set (as described below).

In the example shown, the routing and moderation platform 104 selects an appropriate generative AI system to which input queries from tenant systems 101 are to be submitted. The routing and moderation platform 104 may also integrate with other enterprise systems and resources, including, in the example shown, enterprise data systems 103 and enterprise machine learning (ML) systems 104. Enterprise data systems 103 may include any processing or data storage system that may be available within the enterprise. Such enterprise data systems 103 may include codebases, item databases, sales records, item or customer data, employee information, store or office hours/location information, inventory information, and the like. Enterprise ML systems 104 may include various prediction models that may be employed by the enterprise to assist with business planning, such as demand models, sales models, pricing models, inventory location models, and the like.

In example implementations the routing and moderation platform 104 may be used to incorporate further contextual information from the enterprise data systems 103 and/or enterprise ML systems 104 into input queries that are submitted to one or more of the LLMs 105, 106. For example, a input query received from an enterprise tenant 101 (e.g., a question submitted by an enterprise employee such as a product planner) comparing historical and future sales performance information about a particular item for sale by the enterprise may result in retrieval of item information (e.g., item description, price, in-stock status, historical sales data, and the like) from the enterprise data systems 103, as well as forecast information from the enterprise machine learning systems 104, which may be submitted to an enterprise LLM to generate a narrative response synthesizing and summarizing a comparative analysis of that information.

Additionally, in some instances, the input query and contextual information may be submitted to two or more LLMs from among LLMs 105, 106, with a resulting answer being selected from among the answers received, for example based on comparative scoring of the quality and/or responsiveness of each received answer. Furthermore, other use cases may utilize only enterprise data systems 103 or enterprise machine learning systems 104 in association with LLMs 105, 106.

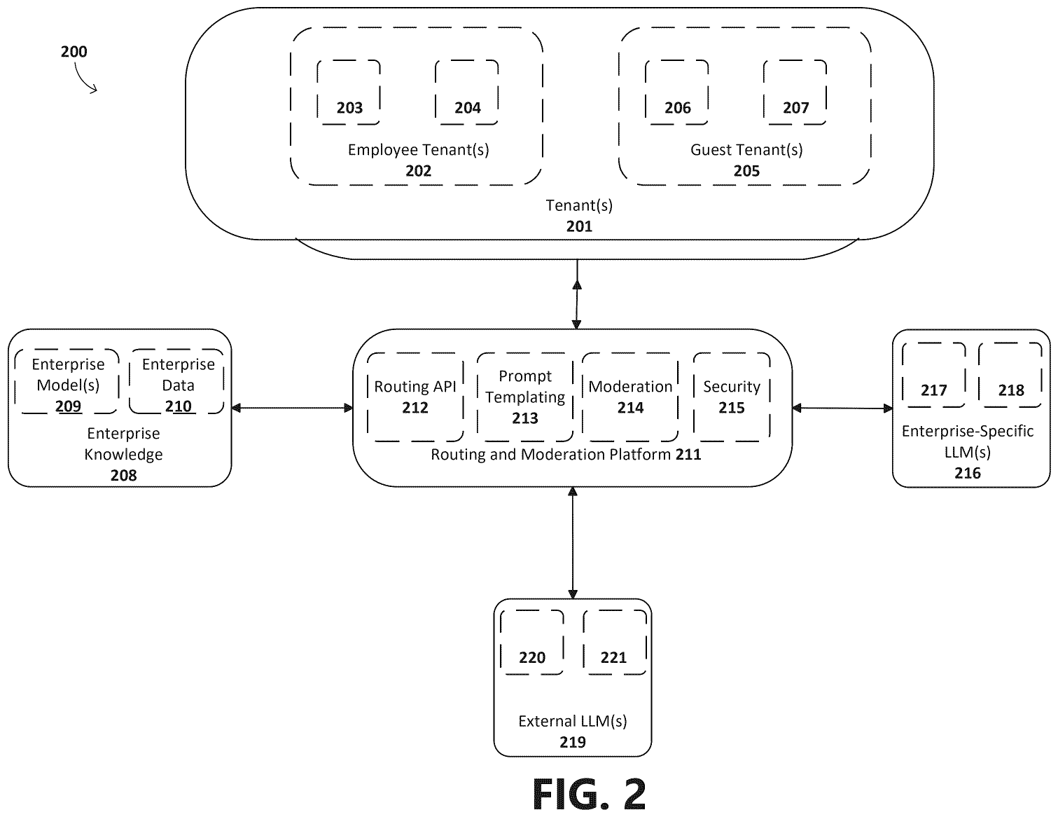

Referring now to FIG. 2, an environment 200 is illustrated in which such a routing and moderation platform may be implemented in the context of a retail enterprise having a digital presence (e.g., a retail website and/or access to order items via a mobile application) as well as a geographically-dispersed set of retail locations. In this context, a set of tenants 201 may include a wide variety of types of tenants, including generally, employee tenants 202 and guest tenants 205, which are each able to access generative AI systems via a routing and moderation platform 211.

In the example shown, the one or more tenants 201 may receive an input query from a tenant. The one or more tenants 201 may be one or more employee tenants 202 or one or more guest tenants 205. The one or more guest tenants 205 may be accessed by a customer of the enterprise.

In the example shown in FIG. 2, the one or more employee tenants 202 can include a first employee tenant 203 and a second employee tenant 204. The one or more employee tenants 202 can include a tenant customized for use by a group of employees within a retail enterprise including store team members, code developers, scientists, engineers, designers, executives, marketing employees, product managers, or call center agents. In one embodiment, store team member tenant could receive an input query to efficiently determine where a product is stocked in a store. In another embodiment, a code developer tenant could receive an input query regarding existing repositories of code to more efficiently complete a project. In some embodiments, a marketing employee tenant could receive an input query to determine customer interests. In a different embodiment, a product manager tenant could receive an input query to determine different product versions and their geographic performance. In another embodiment, a call center agent tenant could receive an input query to find information to assist in providing a customer resolution. In another embodiment a general employee tenant could receive a general input query from be any employee within a retail enterprise.

In the example shown in FIG. 2, the one or more guest tenants 205 can include a first guest tenant 206 and a second guest tenant 207. In one embodiment, a guest tenant could receive an input query about in-stock status or item location within a retail location. In another embodiment, the guest tenant could receive an input query regarding a product return or delivery. In still another embodiment, a guest tenant could receive an input query requesting a product recommendation from a category of product offerings.

In the example shown in FIG. 2, once a tenant receives one or more input query, the one or more input query is routed to a routing and moderation platform 211. The routing and moderation platform 211 may act as a moderator between tenants 201 and one or more enterprise-specific LLMs 216 and/or one or more external LLMs 219. The enterprise-specific LLMs 216 may include one or more enterprise-specific LLMs 217, 218 that are enterprise specific and created and/or managed by the enterprise. The external LLMs 219 may include one or more external LLMs 220, 221 that were created and/or developed by an external entity. The routing and moderation platform 211 may also receive enterprise knowledge inputs 208 including one or more enterprise models 209 and proprietary enterprise data 210. The routing and moderation platform 211 may include a routing API 212 which determines which LLM the input question is submitted to. In determining which LLM the input query is submitted to, the routing API 212 may evaluate which tenant 201 received the input query, what information is needed to answer the input query, and which LLM is best suited to answer the input query. In making this determination, the routing API 212 may incorporate enterprise knowledge inputs received by the routing and moderation platform 211. The LLM that is determined to be best suited to answer the input query may be an enterprise-specific LLM 216 or an external LLM 219.

In some examples, the routing API 212 determines the LLM that a tenant input query is submitted to based on the identity of the tenant user. For example, each tenant user may be associated with a default LLM based on the user's role within or outside the enterprise. For example, input queries from a data scientist within the enterprise may be assigned to a default LLM that is an enterprise-specific LLM 216 and input queries from a customer of the enterprise may be assigned to a default LLM that is an external LLM 219 or vice versa.

In addition to identifying the LLM to submit a tenant input query to based on user identity, the routing API 212 may also consider the current throughput of the available LLMs when identifying the appropriate LLM for the tenant input query. For example, when a default LLM that is associated with a particular tenant is unavailable or does not have the capacity to handle the input query, the routing API 212 may determine another LLM to send the tenant input query to. In some examples, the routing API 212 may select another LLM within the same group. For example, if the default LLM associated with the tenant is one of the enterprise-specific LLMs 216, then upon the determining that the particular enterprise-specific LLM is unavailable or does not have the capacity to handle the input query, then the routing API 212 may select another LLM from the enterprise-specific LLMs 216. Similarly, if the default LLM associated with the tenant is one of the external LLMs 210, then upon determining that the particular external LLM is unavailable or does not have the capacity to handle the input query, then the routing API 212 may select another LLM from the external LLMs 219.

Other factors when considering alternate LLMs may include whether the tenant prefers an LLM that has the capacity to handle the input query with accuracy, but will need longer response times or whether the tenant prefers an LLM that has a faster response time, but the response is less accurate. The routing AP 212 may thus identify an alternative LLM to route the input query to when the default LLM associated with the tenant is unavailable or does not have the capacity to handle the input query based on additional factors and tenant preferences such as capacity of the LLM, response time and level of accuracy needed for the response.

Alternatively, the routing API 212 may determine the default LLM that a tenant input query is submitted to based on other factors, such as the content of the input query and the identifying the best LLM that can respond to that type of query or task. Other ways of identifying the default LLM to submit a tenant input query to include on the basis of: domain expertise, performance metrics, cost efficiency, user specified preferences and load balancing and availability needs.

In the example shown, the routing and moderation platform 211 includes a prompt templating service 213. The prompt templating service 213 receives an input query from tenants, and generates a prompt to the LLM identified by the routing API 212. For example, the prompt templating service may be configured to receive input query text from tenants 201, reformulate those input queries according to standardization techniques and/or best practices for obtaining responsive answers to such input queries, add any further contextual information required from enterprise systems, and submit such reformulated and contextualized input queries to the selected LLM.

The prompt generated by the prompt templating service 213 may include a combination of a user prompt, which includes the input query from the tenant, and a system prompt, which includes instructions and contextual information associated with the input query. In some examples, the system prompt may use a retrieval augmentation generation (RAG) based technique to retrieve the contextual information for the system prompt.

The prompt templating service 213 may include a RAG API that analyzes the input query and retrieves appropriate contextual information from the enterprise knowledge 208. The RAG API may interface with one or more embedding models to facilitate the retrieval of the contextual information associated with the input query. For example, the enterprise models 208 may include an embedding model that is used to create vector embeddings of the documentations, processes, products, etc internal to the enterprise to create the enterprise data 210. When a new input query is received, the prompt templating service 213 may create embeddings of the input query using the same embedding model used to create the vector embeddings of the enterprise data 210 to create input query vector embeddings. The RAG API may then conduct a search within the enterprise data 210 to identify the relevant contextual information to the input query. One example of identifying relevant contextual content may include calculating a a cosine similarity value and identifying content with a cosine similarity value that is over a threshold value to be relevant contextual information. Upon identifying the relevant contextual information, the prompt templating service 213 may add the contextual information to the system prompt.

In addition to the system prompt including the contextual information, the system prompt may also include instructions regarding how to interpret the query and generate the response. The instructions may include details regarding the tone and style of the response, task definition, formatting and structural additions, safety and ethical filters, system level instructions to define the baseline behavior of the model such as “you are a helpful assistant that provides accurate and concise information”, etc. The additional instructions that are added to the system prompt is dependent on the context of the user query and the type of LLM selected by the routing API service 212.

The prompt templating service 213 thus creates a prompt from an input query that is much larger than the initial input query itself by augmenting additional information, such as the contextual information and instructions to assist in efficient and accurate interpretation and processing of the input query by the selected LLM. In an example, the prompt templating service 213 tokenizes the prompt before feeding the tokenized prompt to the LLM selected by the routing API 212.

Generally, LLMs have token limits. A token limit is the maximum number of tokens that the LLM can process in a single interaction. For example, GPT 4 typically supports up to 32,000 tokens including input and output. In addition, each tenant may also have token limit per time period to reduce costs and ensure LLM availability. Streamlining or tuning the overall generated prompt may help reduce the number of tokens generated by the prompt and can assist in an input query not hitting the token limit of the selected LLM or the tenant.

Although the prompt templating service 213 cannot control the number of tokens created by the input query received from a tenant, the prompt templating service 213 may perform a prompt tuning operation to refine the system prompt with the goal of reducing the number of tokens that are sent to the selected LLM. In some cases, the prompt tuning may be based on the token limits of the selected LLM. In other cases, the prompt tuning may be performed on the system prompt by default.

For example, the prompt templating service 213 may initially put together a system prompt as discussed above, but before combining the system prompt and the user prompt to create the overall prompt, the prompt templating service 213 may performing a prompt tuning operation on the system prompt to simplify the language, eliminate any redundant instructions, remove any unnecessary context and limit the amount of contextual information included within the system prompt, shorten or re-phrase sentences by using abbreviations, and truncate excessive background information. The system may be tuned using other techniques as well.

Upon the prompt templating service 213 generating the prompt, including the system prompt and the user prompt, the prompt templating service 213 sends the generated prompt to the LLM selected by the routing API 212 for the selected LLM to process the prompt.

In the example shown, the routing and moderation platform 211 also includes a moderation service 214. The moderation service 214 receives a response that is obtained from the selected LLM to which input query is submitted. In such instances, the moderation service 214 evaluates the response provided by the one or more enterprise-specific LLMs and/or one or more external LLMs based on several factors.

The moderation service 214 is configured to filter, modify and/or block responses from an LLM based on quality factors such as accuracy and relevance, safety, bias and fairness, and compliance with enterprise's tone, legal, and ethical guidelines set forth by the enterprise. For example, the moderation service 214 may interface with an enterprise model 209 to evaluate the response received from the selected LLM. The moderation service 214 may send the initial input query, the overall prompt generated by the prompt templating service 213, the response generated by the selected LLM and the evaluation criteria to evaluate the response on to the enterprise model 209 and request the enterprise model 209 to evaluate that the generated response meets certain standards set forth by the enterprise.

The enterprise model 209 may include an evaluation LLM that receives the evaluation request and interfaces with a database of ground truth data to arrive at an evaluation score based on one or more evaluation criteria. Ground truth is accurate and reliable information related to a particular subject matter that has previously been verified and validate by a human user. For example, when a LLM receives a user query and presents a response to the user query, the LLM may also send a request for the user to evaluate the accuracy and completeness of the response. If the user scores the response to the user query as being highly accurate and complete, the input query and the corresponding response may be stored in a database as a ground truth that the evaluation LLM can later rely on as accurate information.

When a request for an evaluation of a response from a selected LLM is received by the enterprise model 209, the enterprise model 209 may search the database of ground truths to identify similar input queries and corresponding responses to make an assessment on whether the received response aligns with the ground truth when scoring the received response on the various evaluation criteria.

Although the use of ground truths to evaluate a received response is described above, the enterprise model 209 may use other methodologies, including automated metrics, human evaluations and domain-specific criteria to comprehensively assess the performance of the selected LLM and the generated response.

An example of a methodology of scoring answers is described in further detail below. In some examples, a received response may be scored on a plurality of evaluation criteria and the average of the scores may be used to compare against a predetermined threshold score to determine whether the received response may be presentable to the tenant. In other examples, even if the received response was evaluated as having an average score that is above the predetermined threshold score, if the enterprise model 209 determines that the received response includes statements that do not comply with the enterprise's tone and/or ethical and legal standards, then the response may be flagged and not presented to the tenant. In yet other instances, a user query may be sent to more than one enterprise-specific LLM or more than one external LLM. In these instances, the routing and moderation platform 211 will provide a response to the tenant 201 that includes the received response with the highest score.

If the enterprise model 209 determines that the average score for a particular received response does not meet the predetermined threshold score, or includes a flag for not meeting the tone and/or ethical and legal standards of the enterprise, the routing and moderation platform 211 may modify elements of the prompt that was submitted by changing the contextual data that was included and/or the additional instructions included within the system prompt and re-submit to the same LLM that was previously selected by the routing API 212 or re-submit to a different LLM.

Generally, the one or more evaluation criteria set forth by the enterprise may include evaluating for: hallucinations, toxicity, response relevancy, consistency, diversity, fluency, coherence, context awareness, bias, understanding ambiguity.

Evaluating for hallucinations include determining if the model generates information that is not present in the put or is factually incorrect. The moderation service 214 may evaluate for hallucinations by comparing the generated response with known facts or reference or contextual data to identify instances of hallucinations.

Evaluating for toxicity include assessing whether the generated response includes offensive, harmful or inappropriate content. The moderation service 214 may evaluate for toxicity by employing toxicity detection models or human annotators to identify and quantify offensive language.

Evaluating for response relevancy includes evaluating how well the generated response addresses the input query. The moderation service 214 may evaluate for response relevancy by measuring semantic similarity between the generated response and a reference response/ground truth or assessing relevance based on specific criteria.

Evaluating for consistency includes checking if the model provides consistent responses to similar inputs. The moderation service 214 may evaluate for consistency by submitting multiple variations of the same input and analyzing the consistency of the generated responses.

Evaluating for diversity includes examining the diversity of the responses generated for a range of inputs. The moderation service 214 may evaluate for diversity by calculating metrics that quantity diversity, such as uniqueness or the variety of topics covered in the responses.

Evaluating for fluency includes assessing how smoothly and naturally the generated text flows. The moderation service 214 may evaluate for fluency by leveraging language modeling metrics or human annotators to rate the fluency of the generated responses.

Evaluating for coherence includes evaluating the logical and contextual flow of the generated response. The moderation service 214 may evaluate for coherence by using coherence measures or human annotators to assess how well the generated text maintains a cohesive narrative or argument.

Evaluating for context awareness includes verifying if the model takes into account the context provided in the input query. The moderation service 214 may evaluate for context awareness by analyzing responses to contextual prompts and assessing whether the generated content appropriately incorporates the context.

Evaluating for bias includes identifying and quantifying bias in the language model's responses. The moderation service 214 may evaluate for bias by utilizing bias detection tools or employing human annotators to assess and quantify bias in the generated text.

Evaluating for understanding ambiguity includes assessing how well the model handles ambiguous or multifaceted inputs. The moderation service 214 may evaluate by providing inputs with varying interpretations and evaluating the model's ability to generate contextually appropriate responses.

In some embodiments, the routing and moderation platform 211 may include a security service 215. In example implementations, the security service 215 determines security levels for different tenant users, and manages data access in response thereto. For example, there may be one security level for users of the one or more employee tenants 202 and a second security level for users of the one or more guest tenants 205. Employee tenants may be allowed access to contextual information from within the enterprise knowledge 208 when submitting an input query and may receive responses to the input query based on such proprietary information. On the other hand, guest tenants 205 may be limited to some subsets of enterprise knowledge 208 that are not considered proprietary, confidential, or internal, such as stock status, pricing, store hours, and the like.

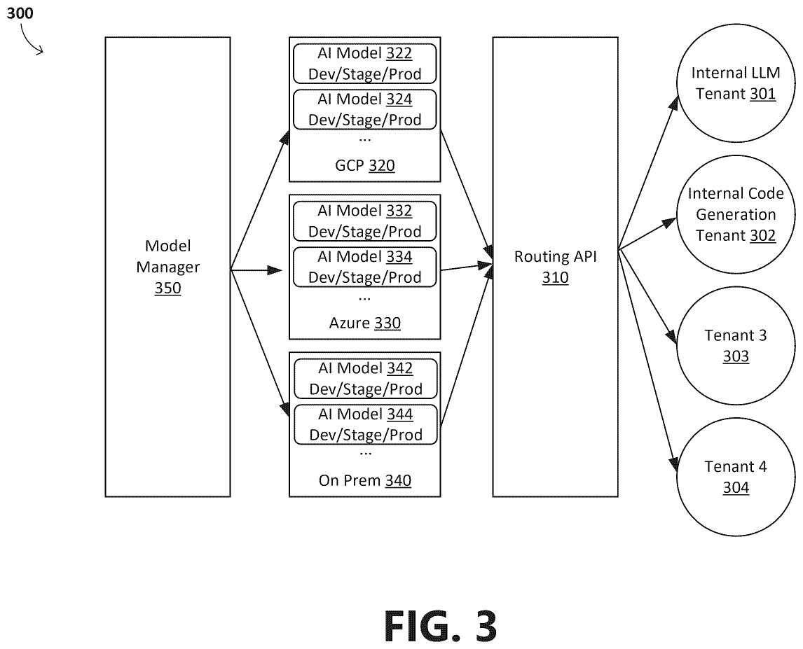

FIG. 3 illustrates an example environment 300 in which a routing and moderation platform may be implemented in the context of a retail enterprise. In this environment, a model manager 350 includes a service architecture for hosting and managing machine learning models and the data that is used to train those models. For example, a first AI model 322 and a second AI model 324 could be hosted within a cloud platform such as GCP 320. The first AI model 322 may be a specific purpose or a general-purpose model. A cloud platform such as Azure 330 could also host a first AI model 332 and a second AI model 334. A first AI model 342 and a second AI model 344 could also be hosted on premise or On Prem 340 and could be for a specific purpose for general purpose.

A routing API 310 may receive messages from the model manager 350, which may be delivered to a plurality of LLMs. The routing API 310 may act as an interface layer to moderate and enable access to a plurality of LLMs that an input query is submitted to. The plurality of LLMs may include specific purpose tenants such as an internal LLM tenant 301 or a code generation tenant 302. The plurality of LLMs may include general purpose tenants such as a third tenant 303 or a fourth tenant 304. The plurality of LLMs may include enterprise tenants and external tenants. In one embodiment, the plurality of LLMs could include 50-100 tenants. In a different embodiment, the plurality of LLMs could include more than 100 tenants.

In one embodiment, the internal code generation tenant 302 may be an enterprise-specific LLM that is trained using an enterprise dataset, such as an enterprise codebase stored in a code repository, in order to generate enterprise-specific responses to input queries, such as to generate compatible enterprise source code to assist developers with coding tasks.

For example, an internal user may submit an input query asking what the demand forecast for a particular product may be in the next week. Here, the routing API 310 may deliver the message to a specific-purpose tenant capable of providing demand forecasting. In one embodiment, a demand forecasting AI model may further include sub-models such as a price elasticity model or a seasonality model.

In another example, an internal user may submit an input query asking for a subset of users to provide with a promotional coupon. In this example, the routing API 310 may deliver the message to a calibration tenant hosted on premise that is able to identify a subset of guest users based on a user's predicted response.

In another example, an external tenant may submit an input query for a product recommendation within a product category. Here, a special purpose on-prem tenant could be used to provide an external user with product recommendations. Example machine learning models that may be implemented in a recommender system are described in U.S. patent application Ser. No. 18/317,593, filed on May 15, 2023, the disclosure of which is hereby incorporated by reference in its entirety.

In deciding which model an input query is submitted to, the routing API 310 may evaluate which tenant received the input query and what information is needed to answer the input query. In one embodiment, the routing API 310 may evaluate which model is best suited to answer the input query by comparing the cost of different models, the responsiveness of different models, or historical quality information. For example, the routing API 310 may detect that an internal tenant has submitted a general input query. In this case, the routing API 310 may select a model by weighing 1) response evaluation criteria associated with responses from models to similar input queries in the past with 2) the relative cost for each model to receive an input query and provide a response and 3) the responsiveness of each of the models.

Historical quality information may include an evaluation of success rates of a given model for a particular input query type. For example, an input query may be categorized as a particular query type based on whether it was submitted by an external or internal tenant, the inclusion of key words, or whether a response requires use of enterprise knowledge. In this example, responses for the particular input query type may be determined to be successful or not based on a user's feedback or use of follow-up queries.

In one embodiment, the routing API may evaluate different models based on privacy controls. For example, the routing API may determine whether the user submitting an input query has access to private enterprise information or not. In one embodiment, an input query may be submitted by an internal user and, therefore, may have access to private enterprise knowledge or private enterprise models. In a different example, the routing API may determine whether the user submitting an input query has rejected a request to provide their user data to external parties and, therefore, their input queries must be routed to an internal LLM.

In another embodiment, the routing API may evaluate different models based on whether they are tuned to provide code responses or text responses. For example, a tenant associated with an internal code developer may submit an input query to access a sample of code to facilitate the development of new models. Here, the routing API may only route the input query to models tuned to provide code responses. In a different example, the routing API may detect that a guest tenant submitted a general product question in natural language and, therefore, will direct the input query to LLMs tuned to return natural language responses.

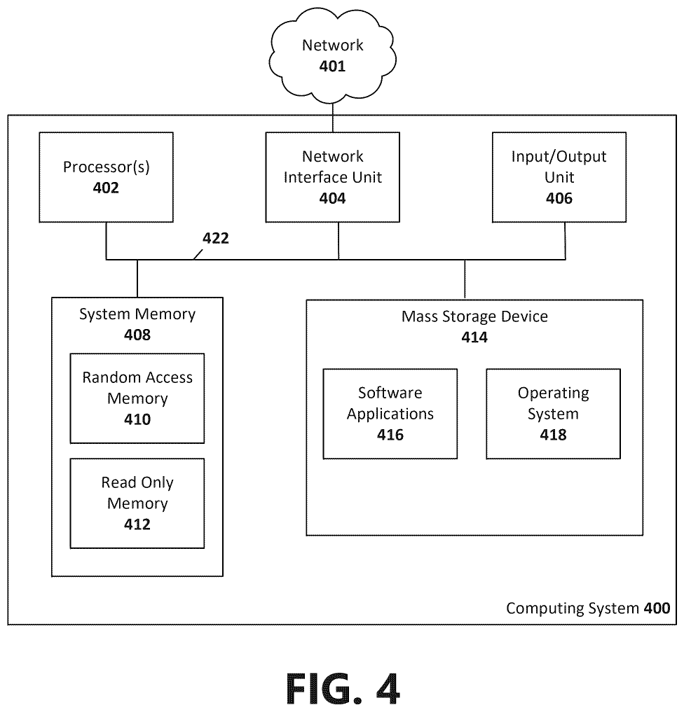

FIG. 4 illustrates an example block diagram of a virtual or physical computing system 400. One or more aspects of the computing system 400 can be used to implement the processes described herein.

In the embodiment shown, the computing system 400 includes one or more processors 402, a system memory 408, and a system bus 422 that couples the system memory 408 to the one or more processors 402. The system memory 408 includes RAM (Random Access Memory) 410 and ROM (Read-Only Memory) 412. A basic input/output system that contains the basic routines that help to transfer information between elements within the computing system 400, such as during startup, is stored in the ROM 412. The computing system 400 further includes a mass storage device 414. The mass storage device 414 is able to store software instructions and data. The one or more processors 402 can be one or more central processing units or other processors.

The mass storage device 414 is connected to the one or more processors 402 through a mass storage controller (not shown) connected to the system bus 422. The mass storage device 414 and its associated computer-readable data storage media provide non-volatile, non-transitory storage for the computing system 400. Although the description of computer-readable data storage media contained herein refers to a mass storage device, such as a hard disk or solid state disk, it should be appreciated by those skilled in the art that computer-readable data storage media can be any available non-transitory, physical device or article of manufacture from which the central display station can read data and/or instructions.

Computer-readable data storage media include volatile and non-volatile, removable and non-removable media implemented in any method or technology for storage of information such as computer-readable software instructions, data structures, program modules or other data. Example types of computer-readable data storage media include, but are not limited to, RAM, ROM, EPROM, EEPROM, flash memory or other solid state memory technology, CD-ROMs, DVD (Digital Versatile Discs), other optical storage media, magnetic cassettes, magnetic tape, magnetic disk storage or other magnetic storage devices, or any other medium which can be used to store the desired information and which can be accessed by the computing system 400.

According to various embodiments of the invention, the computing system 400 may operate in a networked environment using logical connections to remote network devices through the network 401. The network 401 is a computer network, such as an enterprise intranet and/or the Internet. The network 401 can include a LAN, a Wide Area Network (WAN), the Internet, wireless transmission mediums, wired transmission mediums, other networks, and combinations thereof. The computing system 400 may connect to the network 401 through a network interface unit 404 connected to the system bus 422. It should be appreciated that the network interface unit 404 may also be utilized to connect to other types of networks and remote computing systems. The computing system 400 also includes an input/output controller 406 for receiving and processing input from a number of other devices, including a touch user interface display screen, or another type of input device. Similarly, the input/output controller 406 may provide output to a touch user interface display screen or other type of output device.

As mentioned briefly above, the mass storage device 414 and the RAM 410 of the computing system 400 can store software instructions and data. The software instructions include an operating system 418 suitable for controlling the operation of the computing system 400. The mass storage device 414 and/or the RAM 410 also store software instructions, that when executed by the one or more processors 402, cause one or more of the systems, devices, or components described herein to provide functionality described herein. For example, the mass storage device 414 and/or the RAM 410 can store software instructions that, when executed by the one or more processors 402, cause the computing system 400 to receive and execute managing network access control and build system processes.

### II. Operations of Routing and Moderation Platform

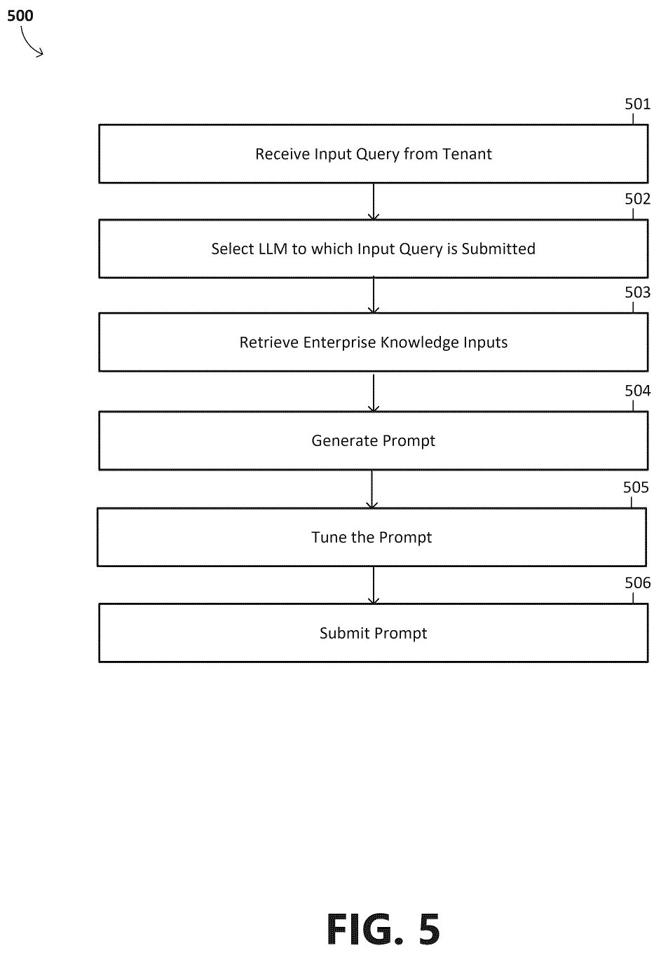

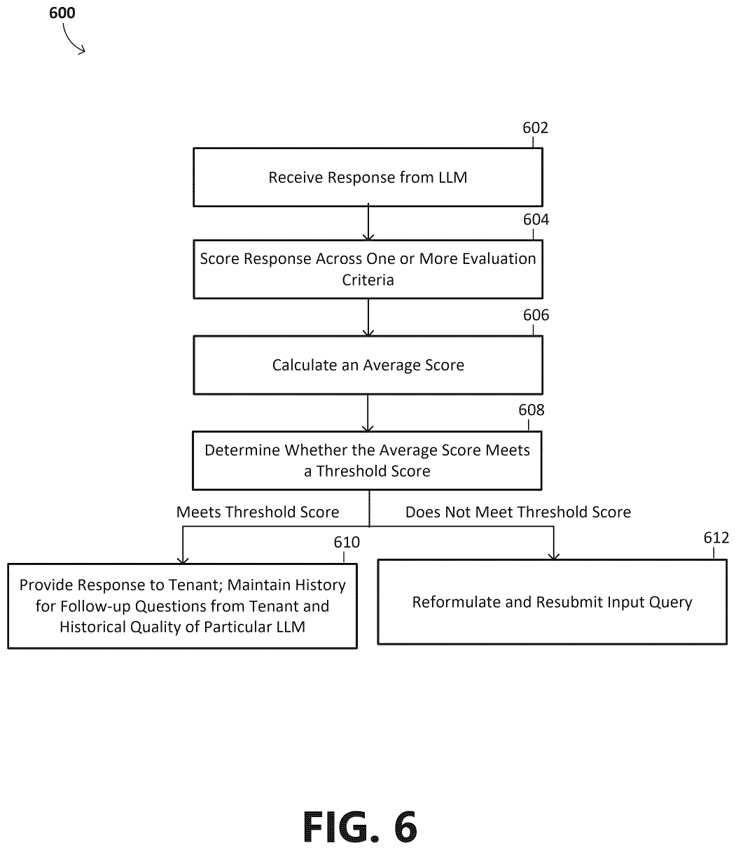

Referring now to FIGS. 5-6, details regarding methods of handling input queries received from tenants are described, as well as moderation and scoring techniques for determining quality and responsiveness of responses to the input queries, and moderating such responses appropriately. Generally, the methods described herein may be performed using a routing and moderation platform, for example as described in Part I.

A particular example method 500 of receiving and managing input queries submitted from a tenant is described in conjunction with FIG. 5. The method 500 includes operations 501, 502, 503, 504, 505, and 506. In one embodiment, the method 500 is performed by the routing API 212 shown in FIG. 2. The routing API 310 is further described in connection with FIG. 3.

In the example shown, method 500 includes receiving an input query from a tenant 501. In one embodiment, the input query is received from a tenant 101 at a routing and moderation platform 104 of FIG. 1. In some instances, the input query may be received at a routing API 212 of the routing and moderation platform 211 of FIG. 2. Receiving an input query from the tenant may include receiving a connection from a particular tenant, such as an employee tenant 202 or a guest tenant 205, for example from a web application, mobile application, or other enterprise application. The input query can include an arbitrary amount of words and/or user-provided natural language and code, or other types of textual input (e.g, in the case the input query is about how to write source code to achieve a particular effect). In some instances, the input query may include images or other input data.

The operation 502 includes selecting one or more LLM to which an input query is submitted. The one or more LLM may include one or more enterprise-specific LLM 216 and/or one or more external LLM 219. In one example, the routing API 212 may select one or more LLM to which an input query is submitted based on which tenant 201 submitted the input query. For example, each tenant may include a default LLM associated with the tenant. Typically, the routing API 212 may select the default LLM to submit the input query, unless there are issues with throughput and/or availability with the default LLM.

For example, the routing API 212 considers various factors, including the current throughput of available LLMs, when determining the appropriate LLM to handle a tenant's input query. If the default LLM associated with a tenant is unavailable or lacks the capacity to handle the input query, the routing API 212 will select an alternative LLM. In some cases, the routing API 212 may choose another LLM within the same group. For instance, if the default LLM is one of the enterprise-specific LLMs 216 and is unavailable or unable to handle the input query, the routing API 212 will select an alternative LLM from the enterprise-specific LLMs 216. Similarly, if the default LLM is one of the external LLMs 210 and is unavailable or unable to handle the input query, the routing API 212 will select another LLM from the external LLMs 219.

Although the selection of an LLM based on the tenant identity is discussed above, the routing API 212 may select the LLM to respond to the input query based on other criteria. In an example, the routing API 212 may select one or more LLMs to which an input query is submitted based on whether the one or more LLMs is an internal LLM or an enterprise-specific LLM. In a different example, the routing API 212 may select one or more LLMs based on what information is needed to respond to the input query. In one embodiment, the routing API 212 may select one or more LLMs based on the cost to submit and receive a response from the one or more LLMs. In a different embodiment, the routing API may select one or more LLMs based on the specific training of the LLM. For example, an LLM may be trained to provide responses for a specific use case such as a guest user inquiring whether an item is in-stock. In another embodiment, the routing API 212 may select one or more LLMs based on the responsiveness of the one or more LLMs. In another embodiment, the routing API 212 may select one or more LLMs based on the throughput and availability of the LLM.

The operation 503 includes retrieving enterprise knowledge inputs. The enterprise knowledge may be retrieved by the prompt templating service 213. In one embodiment, the enterprise knowledge input retrieved by the prompt templating service 213 may be retrieved from one or more enterprise models 209. In another embodiment, the enterprise knowledge input retrieved by the prompt templating service 213 may include data retrieved from enterprise data system(s) 210.

For example, in operation 503, the prompt templating service 213 interfaces with a RAG API to analyze the input query and retrieve relevant contextual information from the enterprise knowledge 208. The RAG API interfaces with the enterprise models 208 to facilitate the retrieval of contextual information associated with the input query. For example, the enterprise models 209 may include an embedding model that generates vector embeddings of internal documentation, processes, products, etc. included within the enterprise data 210. Upon receiving a new input query, the prompt templating service 213 generates embeddings of the input query using the same embedding model employed to create vector embeddings of the enterprise data 210, thereby producing input query vector embeddings. The RAG API subsequently performs a search within the enterprise data 210 to identify relevant contextual information for the input query. For example, the prompt templating service 213 may interface with the RAG API to identify relevant contextual content by calculating cosine similarity values between the embeddings of the entity data 210 and the embeddings of the user query. The prompt templating service 213 may then select content within the enterprise data 210 with cosine similarity values exceeding a predetermined threshold as the relevant contextual content.

In addition to retrieving contextual content, the prompt templating service 213, in operation 503, is also configured to generate additional instructions on interpreting the query and generating the response. These additional instructions encompass various aspects, such as tone and style of the response, task definition, formatting and structural additions, safety and ethical filters, and system-level instructions defining the baseline behavior of the model (e.g., “you are a helpful assistant that provides accurate and concise information”). The additional instructions may depend on the context of the user query and the type of LLM selected by the routing API service 212 in operation 502.

In operation 504, the prompt templating service 213 may generate a prompt that includes the input query received from the tenant in operation 501, and the contextual information and additional instructions retrieved from the enterprise knowledge inputs in operation 503.

The operation 505 further includes reformulating the prompt generated in operation 504 in order to optimize the response from the LLM and to ensure that the response aligns closely with the tenant's intent. Tuning the prompt therefore helps achieve precise, relevant, and effective responses to user queries. In addition, the tuning of the prompt may help reduce the efficiency and cost for the LLM by reducing the number of tokens submitted to the LLM. By tuning the prompt to focus on brevity, clarity, and specificity, the token consumption in both the prompt and the response may be reduced while still maintaining the effectiveness of the prompt. The tuning may also help avoid exceeding token limits set forth by LLMs or token limits associated with the tenant.

In one embodiment the input query may be reformulated or tuned by the prompt templating service 213 as described in connection with FIG. 2. For example, the prompt templating service may be configured to receive query text from one or more tenants 201, reformulate those input queries according to standardization techniques, including input query templates, and send the reformulated prompt to the routing API 212 for submission to the selected LLM. In one embodiment, reformulating an input query may include compressing the prompt to reduce the number of tokens of the prompt. For example, the prompt templating service may tune or reformulate the prompt by simplifying language, eliminating redundant instructions, removing unnecessary context, limiting the amount of included contextual information, employing abbreviations to shorten or rephrase sentences, and truncating excessive background information. Other techniques may also be utilized for tuning the system prompt.

The operation 506 includes submitting the tuned prompt generated in operation 505 to the LLM selected in operation 502. As described in connection with FIG. 2, the LLM to which the input query is submitted may be one or more enterprise-specific LLM 216 or one or more external LLM 219. In example implementations, an enterprise-specific LLM 216 may be an LLM that is tuned to answer input queries likely to be asked of the enterprise, and may have be trained or tuned using a customized dataset. In example implementations, an external LLM 219 may be implemented as a public LLM, such as ChatGPT or one hosted on cloud such as Google Cloud Platform (GCP).

FIG. 6 is a flowchart of an example method 600 for moderation of the input query received from the tenant in accordance with aspects of the present disclosure.

The operation 602 includes receiving a response from the selected LLM upon submission of the prompt associated with a received input query as described in operations 501-506 of FIG. 5. In one embodiment, the response may be received by the routing API 212 of the routing and moderation platform 211 of FIG. 2. Upon receiving the response from the selected LLM, the routing API 212 may interface with the moderation service 214 for further processing of the response before sending the response to the tenant that originally submitted the input query. In another embodiment, the response may be received by the moderation service 214.

The operation 604 includes scoring the response using the moderation service 214 based on one or more evaluation criteria. In one embodiment the response may be received from the selected LLM by the moderation service 214 at a routing and moderation platform 211. In a different embodiment, the routing API 212 may receive the response from the selected LLM and interface with the moderation service 214 to further process the response. In yet another embodiment, the moderation service 214 may be included in the routing API 212.

For example, the moderation service 214 may evaluate and score the received response across a plurality of evaluation criteria. The one or more evaluation criteria of operation 604 may include a measure of hallucination, toxicity, response relevance, consistence, diversity, fluency, coherence, context awareness, bias, and understanding ambiguity. The different evaluation criteria and the process of evaluating each of the evaluation criteria is described in further detail in relation to the moderation service 214 of FIG. 2.

The operation 606 includes calculating an average score using the moderation service 214. For example, when the scores determined by the moderation service 214 in operation 604 for each of the one or more evaluation criteria may be averaged together to determine an average score for the response. In some examples, the average score may be a weighted average score as different evaluation criteria may be weighted differently based on the importance of the particular evaluation criteria on the overall quality of the response in light of the context of the input query. For example, when responding to an input query from a customer tenant, the toxicity may be weighted higher than when responding to an input query from an employee tenant.

The operation 608 includes determining, by the moderation service 214, whether the average score calculated in operation 606 meets a predetermined threshold score. For example, the moderation service 214 may compare the average score or weighted average score calculated in operation 606 to a predetermined threshold score. Upon determining that the average score is equal to or above the predetermined threshold score, the moderation service 214 may determine that the average score meets the threshold score. In such a case, operation 608 transitions to operation 610. Upon determining that the average score is less than the predetermined threshold score, the moderation service 214 may determine that the average score does not meet the threshold score. In such a case, operation 608 transitions to operation 612.

The operation 610 includes providing the response to the tenant that initially sent the input query. In one embodiment, the routing API 212 may provide the selected or created response to the tenant 201 directly. In another embodiment, the routing API 212 may provide the selected or created response to a routing and moderation platform 211 which then provides the response to the tenant 201.

The operation 610 further includes maintaining a history for follow-up input queries from the tenant and for tracking historical quality of the particular selected LLM. In one example, the routing API 212 may maintain a history of the response for use in providing responses to follow-up input queries from the tenant. In another example, the routing API 212 may store the score data associated with response collected from the selected LLM at a data storage system. In one embodiment, the data storage system may be associated with enterprise data systems 103 and may be only available within the enterprise. The score data associated with the LLM may be used to by the routing API to determine a confidence that selected LLM will return a responsive answer above a particular quality threshold in the future.

The operation 612 includes reformulating the input query and resubmitting the input query. For example, upon determining that the average score does not meet the threshold score, the routing and moderation platform 211 may repeat one or more operations from FIGS. 5 and 6. For example, in some cases, the routing and moderation platform 211 may re-select a different LLM than the previously selected LLM and resubmit the same prompt that was previously generated. In other cases, the routing and moderation platform 211 may regenerate the prompt by including modified contextual and/or instructions associated with the input query and re-submit the prompt to the same LLM that was previously selected. In yet other cases, the routing and moderation platform 211 may re-select a different LLM than the previously selected LLM as well as regenerate a modified prompt before re-submitting the modified prompt to the newly selected LLM. Upon receiving a response from the LLM, the routing and moderation platform 211 may perform the operations of FIG. 6 to re-moderate and evaluate the new response from the re-submitted prompt before sending the response to the tenant upon determining the average score of the new response meets the threshold score. In some cases, if the new response still does not meet the threshold score, the routing and moderation platform 211 may once again try modifying the LLM and/or the prompt or the routing and moderation platform 211 may send a message to the tenant saying the input query cannot be answered by the LLM.

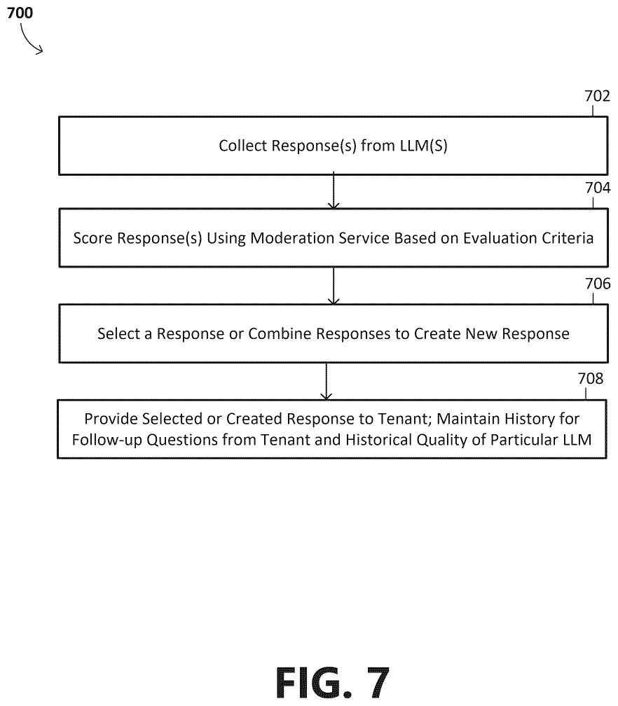

FIG. 7 is a flowchart of another example method 700 for moderation of responses to an input query received from a tenant or plurality of tenants in accordance with aspects of the present disclosure. The method 700 includes operations 702, 704, 706, and 708. In one embodiment, the method 700 is performed by the routing and moderation platform 211 shown in FIG. 2.

Although FIGS. 5 and 6 are described as submitting a prompt associated with an input query and receiving a response from an LLM to the prompt, it is possible that operations of FIGS. 5 and 6 may be configured to submit a prompt generated from a user query to a plurality of LLMs, and receive a plurality of responses from the plurality of LLMs and/or the prompt may be submitted to a single LLM, but may receive multiple alternate responses from the LLM. Operations 702, 704, 706, and 708 describe moderation of responses when an input query is submitted to one or more LLMs and one or more responses are received from the one or more LLMs.

The operation 702 includes collecting one or more response from one or more LLMs. In one embodiment, the response(s) are collected by the routing API 212 of the routing and moderation platform 211 of FIG. 2. The one or more LLMs which the routing API 212 collects the response(s) from may include one or more enterprise-specific LLMs 216 and/or one or more external LLMs 219. The response can include natural language, code, images, or other data.

The operation 704 includes scoring the response(s) using a moderation service 214 based on one or more evaluation criteria. In one embodiment the response(s) may be received from the LLM(s) by a moderation service 214 at a routing and moderation platform 211. In a different embodiment, the moderation service 214 may be included in the routing API 212. For example, the one or more responses may each be evaluated and scored across each of the one or more of evaluation criteria. The different evaluation criteria and the process of evaluating each of the evaluation criteria is described in further detail in relation to the moderation service 214 of FIG. 2.

For example, each response from each of the one or more LLMs is assigned a score so that only responses surpassing a threshold score will be further evaluated by the routing API. In a different example, multiple responses may each be assigned a score so the response with the highest score can be submitted to a user. In another example, the responses may be given scores in several different evaluation criteria so portions of the responses associated with low scores for a particular evaluation criterion can be removed and portions of the responses associated with high scores for a particular evaluation criterion can be kept.

In one example, the response(s) may be given a raw score based on a single evaluation criteria score. In another example, the response(s) may be given a raw score that reflects the total score of several individual evaluation criteria scores added together. In a different example, the response(s) may be given a weighted score that reflects the total score of several evaluation criteria scores where each evaluation criteria score is assigned a different weight. For example, the score of each evaluation criterion may be assigned a different weight based on the relevancy of the evaluation criteria to the submitted question or the particular use case.

The operation 706 includes selecting a response or combining responses to create a new response. In an example, the routing API 212 may receive a collection of responses with associated scores from the moderation service 214. In one example, the routing API 212 may select the response with the highest score based on the combination of one or more individual evaluation criteria score. In a different example, the routing API may select a response based on a particular weighted set of scores or subset of scores that are specific to the particular tenant or question received.

The operation 706 may also include combining responses to create a new response. In one example, the routing API 212 may combine the responses to create a new response by putting multiple responses together that all surpass a threshold score for one or more evaluation criteria. In a different example, the routing API 212 may create a new response by summarizing information from multiple responses that all surpass a threshold score.

In one embodiment, the routing API 212 may select portions of two or more responses that received high scores for different evaluation criteria and filter out portions of two or more responses that received low scores for different evaluation criteria to create a new response.

For example, two or more responses may each have different scores for different evaluation criteria, with each given response having some evaluation criteria receiving high scores and other evaluation criteria receiving low scores. In one embodiment, the highest scoring response can be kept as a base response. Any aspect of the base response that received a poor score for a particular evaluation criterion could then be removed and substituted with a portion of different response that received a high score for that same evaluation criterion to create a new response. In some instances, two or more responses, or portions thereof, may be resubmitted to one or more LLMs for summarization and combination (the same or different LLMs as those from which initial response are received).

The operation 708 includes providing the selected or created response to a tenant. In one embodiment, the routing API 212 may provide the selected or created response to a tenant 201 directly. In another embodiment, the routing API 212 may provide the selected or created response to a routing and moderation platform 211 which then provides the response to the tenant 201.

The operation 708 further includes maintaining a history for follow-up questions from the tenant and for tracking historical quality of the particular LLM(s). In one example, the routing API 212 may maintain a history of the responses for use in providing responses to follow-up questions from the tenant. In another example, the routing API 212 may store the score data associated with responses collected from the LLM(s) at a data storage system. In one embodiment, the data storage system may be associated with enterprise data systems 103 may be only available within the enterprise. The score data associated with the LLM(s) may be used to by the routing API to determine a confidence that LLM(s) will return a responsive answer above a particular quality threshold in the future.

While particular uses of the technology have been illustrated and discussed above, the disclosed technology can be used with a variety of data structures and processes in accordance with many examples of the technology. The above discussion is not meant to suggest that the disclosed technology is only suitable for implementation with the data structures shown and described above. For examples, while certain technologies described herein were primarily described in the context of queueing structures, technologies disclosed herein are applicable to data structures generally.

This disclosure described some aspects of the present technology with reference to the accompanying drawings, in which only some of the possible aspects were shown. Other aspects can, however, be embodied in many different forms and should not be construed as limited to the aspects set forth herein. Rather, these aspects were provided so that this disclosure was thorough and complete and fully conveyed the scope of the possible aspects to those skilled in the art.

As should be appreciated, the various aspects (e.g., operations, memory arrangements, etc.) described with respect to the figures herein are not intended to limit the technology to the particular aspects described. Accordingly, additional configurations can be used to practice the technology herein and/or some aspects described can be excluded without departing from the methods and systems disclosed herein.

Similarly, where operations of a process are disclosed, those operations are described for purposes of illustrating the present technology and are not intended to limit the disclosure to a particular sequence of operations. For example, the operations can be performed in differing order, two or more operations can be performed concurrently, additional operations can be performed, and disclosed operations can be excluded without departing from the present disclosure. Further, each operation can be accomplished via one or more sub-operations. The disclosed processes can be repeated.

Although specific aspects were described herein, the scope of the technology is not limited to those specific aspects. One skilled in the art will recognize other aspects or improvements that are within the scope of the present technology. Therefore, the specific structure, acts, or media are disclosed only as illustrative aspects. The scope of the technology is defined by the following claims and any equivalents therein.

1. A routing and moderation platform comprising:
a routing application programming interface communicatively interfaced to a plurality of tenant devices to:
receive an input query submitted from a tenant device of the plurality of tenant devices; and
identify an LLM-based generative AI system from a plurality of LLM-based generative AI systems to invoke to respond to the input query;
a prompt templating service executable to:
obtain contextual information that is relevant to the input query from one or more enterprise systems;
generate instructions for constructing a response to the input query;
generate a prompt based on the input query, the contextual information and the instructions;
generate a tuned prompt by compressing the number of tokens included within the prompt;
wherein the routing application programming interface is further configured to submit the tuned prompt to the LLM-based generative AI system and receive the response to the input query.

2. The routing and moderation platform of claim 1 further comprising:
a moderation service executable to:
determine a quality level of the response for a plurality of evaluation criteria;
generate quality score for each of the plurality of evaluation criteria based on the quality level for each of the plurality of evaluation criteria;
calculate an average quality score based on an average of the quality score for each of the plurality of evaluation criteria;
determine whether average quality score is above a threshold quality value;
upon determining that the average quality score meets a threshold quality value, send the response to the tenant device; and
upon determining that the average quality score does not meet the threshold quality value, generate a modified prompt with at least one of: modified contextual information and modified instructions and submit the modified prompt to one of: the LLM-based generative AI system or a different LLM-based generative AI system of the plurality of LLM-based generative AI systems.

3. The routing and moderation platform of claim 1, wherein the instructions for constructing the response to the input query includes instructions for interpreting the input query and instructions for constructing the tone and content of the response.

4. The routing and moderation platform of claim 1, wherein the input query comprises textual questions.

5. The routing and moderation platform of claim 1, wherein the tenant devices are associated with a plurality of different types of tenants having different access rights to enterprise data.

6. The routing and moderation platform of claim 5, wherein the tenant devices include customer tenant devices and employee tenant devices.

7. The routing and moderation platform of claim 1, wherein the plurality of different LLM-based generative AI systems include at least one enterprise-hosted LLM model and at least one external LLM model.

8. The routing and moderation platform of claim 1, wherein the quality scores include one or more of: a relevancy score, a toxicity score, a consistency score, a fluency score, a bias score, a diversity score, a hallucination score, a coherence score, a context awareness score and an understanding ambiguity score.

9. The routing and moderation platform of claim 1, wherein the routing application programming interface is configured to submit the prompt to a plurality of the different LLM-based generative AI systems.

10. A routing and moderation platform comprising:
a computing system comprising a processor and a memory, the computing system including instructions which, when executed, cause the routing and moderation platform to perform:
receiving an input query submitted from a tenant device of the plurality of tenant devices; and
identifying an LLM-based generative AI system from a plurality of LLM-based generative AI systems to invoke to respond to the input query;
obtaining contextual information that is relevant to the input query from one or more enterprise systems;
generating instructions for constructing a response to the input query;
generating a prompt based on the input query, the contextual information and the instructions;
generating a tuned prompt by compressing the number of tokens included within the prompt; and
submitting the tuned prompt to the LLM-based generative AI system;
receiving the response to the input query;
generating an average quality score for the response; and
upon determining that the average quality score meets a threshold quality value, sending the response to the tenant device.

11. The routing and moderation platform of claim 10, wherein generating the average quality score for the response includes:
determining a quality level of the response for a plurality of evaluation criteria;
generating quality scores for each of the plurality of evaluation criteria based on the quality level for each of the plurality of evaluation criteria; and
calculating the average quality score based on an average of the quality score for each of the plurality of evaluation criteria.

12. The routing and moderation platform of claim 10, wherein the instructions which, when executed, cause the routing and moderation platform to further perform:
upon determining that the average quality score does not meet the threshold quality value, generating a modified prompt with at least one of: modified contextual information and modified instructions and submit the modified prompt to one of: the LLM-based generative AI system or a different LLM-based generative AI system of the plurality of LLM-based generative AI systems.

13. The routing and moderation platform of claim 10, wherein the contextual information comprises enterprise confidential information.

14. The routing and moderation platform of claim 10, wherein the LLM-based generative AI system is identified based at least in part on historical response quality scores of each of the plurality of LLM-based generative AI systems.

15. The routing and moderation platform of claim 10, wherein the LLM-based generative AI system is identified based at least on part on a cost of submitting the tuned prompt to each of the plurality of LLM-based generative AI systems.

16. A method for routing and moderation of questions received from tenants, the method comprising:
receiving an input query submitted from a tenant device of the plurality of tenant devices; and
determining an LLM-based generative AI system from a plurality of LLM-based generative AI systems to invoke to respond to the input query;
obtaining contextual information that is relevant to the input query from one or more enterprise systems;
generating instructions for constructing a response to the input query;
generating a prompt based on the input query, the contextual information and the instructions;
generating a tuned prompt by compressing the number of tokens included within the prompt; and
submitting the tuned prompt to the LLM-based generative AI system.

17. The method of claim 16, further comprising:
receiving the response to the input query;
determining a quality level of the response for a plurality of evaluation criteria;
generating quality scores for each of the plurality of evaluation criteria based on the quality level for each of the plurality of evaluation criteria;
calculating the average quality score based on an average of the quality score for each of the plurality of evaluation criteria.

18. The method of claim 17, further comprising:
determine whether average quality score is above a threshold quality value; and
upon determining that the average quality score meets a threshold quality value, send the response to the tenant device.

19. The method of claim 17, further comprising:
determine whether average quality score is above a threshold quality value; and
upon determining that the average quality score does not meet the threshold quality value, generate a modified prompt with at least one of: modified contextual information and modified instructions and submit the modified prompt to one of: the LLM-based generative AI system or a different LLM-based generative AI system of the plurality of LLM-based generative AI systems.

20. The method of claim 14, wherein the quality scores include one or more of: a relevancy score, a toxicity score, a consistency score, a fluency score, a bias score, a diversity score, a hallucination score, a coherence score, a context awareness score and an understanding ambiguity score.
